(19) United States
(12) Patent Application Publication
(10) Pub. No.: US 2025/0189638 A1
(43) Pub. Date: Jun. 12, 2025

(54) TIME-OF-FLIGHT SYSTEM AND METHOD

(71) Applicant: Sony Semiconductor Solutions Corporation, Kanagawa (JP)

(72) Inventor: Morin DEHAN, Stuttgart (DE)

(73) Assignee: Sony Semiconductor Solutions Corporation, Kanagawa (JP)

(21) Appl. No.: 18/845,934

(22) PCT Filed: Feb. 28, 2023
(86) PCT No.: PCT/EP2023/055005

§ 371 Date: Sep. 11, 2024

(30) Foreign Application Priority Data
Mar. 18, 2022 (EP) 22163006.4

(51) Int. Cl. G01S 7/4865; G01S 7/481; G01S 7/4861; G01S 17/894

(52) U.S. Cl. CPC G01S 7/4865; G01S 7/4816; G01S 7/4861; G01S 17/894

(57) ABSTRACT

A Time-of-Flight system of the photon counting type comprising circuitry configured to generate illumination pulses and to record the reflected illumination pulses in recording time slots within a recoding period with variable time shifts (t0, t1, t2, t3) between the illumination pulses and the recording time slots.

### TECHNICAL FIELD

The present disclosure generally pertains to the field of Time-of-Flight imaging, and in particular to devices and methods for Time-of-Flight image processing.

### TECHNICAL BACKGROUND

With the continuing development of autonomous driving, traditional 2D cameras are complemented by other camera technologies such as stereo cameras, IR cameras, RADAR, LiDAR, and Time-of-Flight (ToF) cameras.

A Time-of-Flight (ToF) camera is a range imaging camera system that determines the distance of objects by measuring the time of flight of a light signal between the camera and the object for each point of the image. Generally, a ToF camera has an illumination unit (a LED or VCSEL, Vertical-Cavity Surface-Emitting Laser) that illuminates a scene with modulated light. A pixel array in the ToF camera collects the light reflected from the scene and measures phase-shift which provides information on the travelling time of the light, and hence information on distance.

The direct ToF (dToF) method uses a photon counting (PC) technique pulse method in which the pulse width of the laser pulse generated by the lidar system can be changed. By reducing the pulse width, reflections are more easily distinguishable and higher resolution is achieved.

Photon counting ToF systems like the like the dToF system are recording a photon histogram. Current systems are considered to use single photon avalanche diodes (SPADs) as detectors.

PC-ToF uses the number of photons that fall into two or more consecutives bins to get sub-bin resolution during depth calculation. Contrary to dToF, the PC-TOF systems are using a relatively small amount of bins. The duration of one bin, and the light pulse duration are the same, and could be larger than the one of dToF.

Although there exist photon counting (PC) ToF techniques, it is generally desirable to provide better photon counting techniques in order to perform Time-of-Flight distance measurements.

### SUMMARY

According to a first aspect the disclosure provides a Time-of-Flight system of the photon counting type comprising circuitry configured to generate illumination pulses and to record the reflected illumination pulses in recording time slots within a recoding period with variable time shifts between the illumination pulses and the recording time slots.

According to a further aspect the disclosure provides a method comprising generating illumination pulses and recording reflected illumination pulses in recording time slots within a recoding period with variable time shifts between the illumination pulses and the recording time slots.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the effect of photon pile-up caused by the detector dead time;

FIGS. 2a, b, c, and d visualize the dependency of the pile-up effect on the signal strength;

FIG. 3a shows a first example of a subframe definition;

FIG. 3b shows a second example of a subframe definition;

FIG. 4 schematically shows subframe signals for which the recording time slots are defined such that their sum would be equivalent to the signal waveform specified for the system;

FIG. 5a shows an example where an illumination pulse is generated by an illuminator with a variable time shift with respect to the beginning of a recording period.

FIG. 5b shows an example where an illumination pulse is generated, by an illuminator, at the beginning of a recording period.

FIG. 6 schematically shows the effect of pile-up mitigation caused by the subframe illumination;

FIG. 7 shows a target pulse shape that is decomposed in to five shorter pulses;

FIG. 8 compares the reconstructed equivalent impulse obtained according to the sub-pulse scheme technique of the present embodiments with a single pulse that does not use the sub-pulse scheme of the present embodiments;

FIG. 9 schematically shows an example of a ToF delay computation based on the principle of binning;

FIG. 10 shows the impact of the detected pulse shape on the time of flight delay estimation in case of high intensity signals;

FIG. 11 shows the impact of the detected pulse shape on the time of flight delay estimation in case of moderate intensity signals, where the detected pulse is not much impacted by pile-up;

FIG. 12 schematically shows an embodiment of a ToF device; and

FIG. 13 schematically shows an alternative embodiment of a ToF device.

### DETAILED DESCRIPTION OF EMBODIMENTS

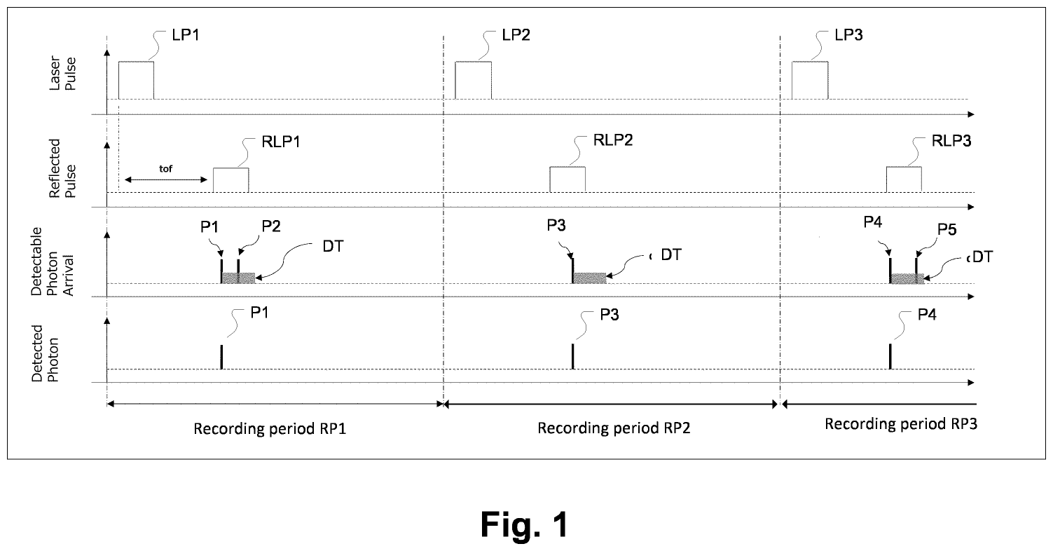

Before a detailed description of the embodiments under reference of FIG. 1, general explanations are made.

The embodiments described below in more detail disclose a Time-of-Flight system of the photon counting type comprising circuitry configured to generate illumination pulses and to record the reflected illumination pulses in recording time slots within a recoding period with variable time shifts between the illumination pulses and the recording time slots.

Recording with a time shift between the illumination pulse and the recording time slot may optimize the illumination of a Photon Counting system. This may improve accuracy by minimizing the impact of pile-up. That is, in case of multiple photon arrival, it may be avoided that only the first one is detected, because of dead time of the detector.

In order to reduce the impact of the pile-up effect, the inventor suggests modifying the illumination/recording pattern, by decomposing it in a succession of shifted subframes.

The Time-of-Flight system may for example be a SPAD based Time-of-Flight system.

Circuitry may include a processor, a memory (RAM, ROM or the like), a storage, input means (mouse, keyboard, camera, etc.), output means (display (e.g. liquid crystal, (organic) light emitting diode, etc.), loudspeakers, etc., a (wireless) interface, etc., as it is generally known for electronic devices (computers, smartphones, etc.). Moreover, it may include sensors for sensing still image or video image data (image sensor, camera sensor, video sensor, etc.), for sensing a fingerprint, for sensing environmental parameters (e.g. radar, humidity, light, temperature), etc.

The circuitry may be configured to acquire, during a recording period, a photon counting histogram, each bin of the photon counting histogram corresponding to recording time slots of the recording period.

The circuitry may be configured to acquire, a frame comprising the recording periods.

The circuitry may be configured to acquire, for each frame, subframes of different type, wherein subframes of the frames of the same type are a collection of recording periods with the same time shift.

In this way, the recording periods of a photon histogram may be attributed to groups which are denoted as “subframes”.

A subframe may for example be a collection of recording periods with the same time shift. For example, the recording time slots of a recording period are all shifted by the same time shift as the respective illumination pulses that belong to the subframe.

A frame may for example be a pattern of subframes that is repeating in time.

The illumination pulse duration may for example be at least as long as the longest time shift increment.

The circuitry may be configured to control the time shift within the recording period by shifting the illumination onset.

The circuitry may be configured to control the time shift within the recording period by shifting the recording time slot.

The illumination pulses for the subframes may for example be defined based on a target equivalent pulse of the corresponding frame such that the illumination pulses of the subframes are equal to the target equivalent pulses of the frame.

The illumination pulses for the subframes may for example be pulses, which when averaged, reconstruct a target pulse. The subframes signal accumulated over the recoding period may thus be equivalent to the single pulse condition (without subframes).

The light pulses of a subframe may for example be defined based on target equivalent pulse of the frames such that, when averaged, the light pulses of the subframes are equal to an equivalent pulse of the frame.

According to the embodiments, the illumination pulses for the subframes may for example be narrower pulses than the target pulse, the narrower pulses when averaged reconstructing the target pulse (without subframes) when building the ToF histogram. This target pulse may for example be the wanted signal waveform required by the ToF system.

The illumination pulses for the subframes may be, compared to a target pulse, short pulses with increased pulse power.

By splitting the target pulse into narrower subframe pulses, the probability of missing an active photon due to the dead time is reduced. Effectively, by using several narrower pulses, the probability of having multiple detectable photons in the pulses get reduced. Also, if some photons are missed within one of the narrower pulse, the impact would be reduced.

By increasing the pulse power for a short pulse, the number of frames can be increased without reducing the SNR. That is, despite the presence of ambient light, reducing the pulse length and increasing the number of frames does not reduce the SNR at long distance, if the pulse power is increased accordingly.

The circuitry may comprise a Photon Counting ToF sensor configured to record the reflected illumination pulses.

The circuitry may comprise an active illuminator. This active illuminator may for example comprise one or more lasers, for example one or more vertical-cavity surface-emitting lasers (VCSELs).

The time shift between the illumination pulse and the recording time slot may for example be generated by a programmable delay generator.

The circuitry may for example comprise a programmable delay generator which is configured to delay an illumination pulse trigger signal. The programmable delay generator may for example be configured to delay the illumination pulse trigger signal as function of the subframe. This programmable delay generator may for example be configured to receive a SPAD record trigger signal and to convert the SPAD record trigger signal into a delayed illumination pulse trigger signal based on a delay index.

In alternative embodiments, the circuitry may comprise a programmable delay generator configured to delay the reference clock of histogram recording.

This programmable delay generator may for example be configured to modify a trigger for SPAD array recording.

The circuitry may be configured to perform a ToF delay computation based on the principle of binning, where each bin corresponds to a recording time slot of the frame.

The recording time slots may for example be defined by a record trigger signal.

The embodiments also disclose a method comprising generating illumination pulses and recording reflected illumination pulses in recording time slots within a recoding period with variable time shifts between the illumination pulses and the recording time slots.

### Photon Pile-Up in PC-TOF

A Photon Counting ToF systems (PC-TOF) as described in the embodiments below illuminates the scene with pulses of laser light and the photons of reflected light that are captured by the ToF sensor are evaluated in a photon histogram. The recording period during which a histogram is captured is segmented into recording time slots of typically equal length. Photons that arrive during the same recording time slot (across multiple recording periods) are attributed to a respective “bin” of the photon histogram. The photon counts from multiple of such recording periods are typically aggregated into a single photon histogram. There can be a variable delay between successive recording periods.

When a SPAD is detecting a photon, it becomes unable to detect another photon during an amount of time called the dead time (see DT in FIG. 1 below). That is, if more than one photon is coming back during one pulse period, some signal level will be lost due to the dead time of the SPAD detector. The accumulated signal stored in histograms will thus show a distortion between the amount of signal hitting the detector and the amount of signal effectively detected. Consequently, the apparent pulse shape detected by the sensor will be distorted. This effect is called “pile-up” effect.

FIG. 1 schematically shows the effect of photon pile-up caused by the detector dead time. In the diagrams of FIG. 1 time is shown on the horizontal axis. Three exemplary recording periods RP1, RP2, RP3 follow after each other. During the first recording period RP1, a laser pulse LP1 is generated. A reflected laser pulse RLP1 is detected after a time delay tof according to the ToF principle. A photon P1 at the beginning of the reflected laser pulse RLP1 is detected by the detector. This detection process is followed by a dead time DT of the detector. A photon P2 in the middle of the reflected laser pulse RP1 arrives during the dead time DT of the detector. This photon P2 is not detected by the detector. During a second recording period RP2, a laser pulse LP2 is generated. A reflected laser pulse RLP2 is detected after a time delay tof according to the ToF principle. A photon P3 at the beginning of the reflected laser pulse RLP2 is detected by the detector. This detection process is followed by a dead time DT of the detector. No other photons of the reflected laser pulse RLP2 arrive at the detector. During a third recording period RP3, a laser pulse LP3 is generated. A reflected laser pulse RLP3 is detected after a time delay tof according to the ToF principle. A photon P4 at the beginning of the reflected laser pulse RLP3 is detected by the detector. This detection process is followed by a dead time DT of the detector. A photon P5 at the end of the reflected laser pulse RLP3 arrives during the dead time DT of the detector. This photon P5 is not detected by the detector. That is, due to the detector dead time, only photons P1, P3, and P4 are detected. Photon P2 “piles-up” with photon P1, and photon P5 “piles-up” with photon P3, so that photons P2 and P5 are not detected.

Due to the dead time of the detector, a reduced amount of photons will be detected by the detector as illustrated in FIG. 1 above.

Pile-up can cause saturation. PC-ToF measurements typically show such saturation effects for objects that are in close range.

The distortion of the signal caused by the pile-up effect depends of the signal strength. It is dependent of the target being detected by the sensor. This makes it difficult to compensate.

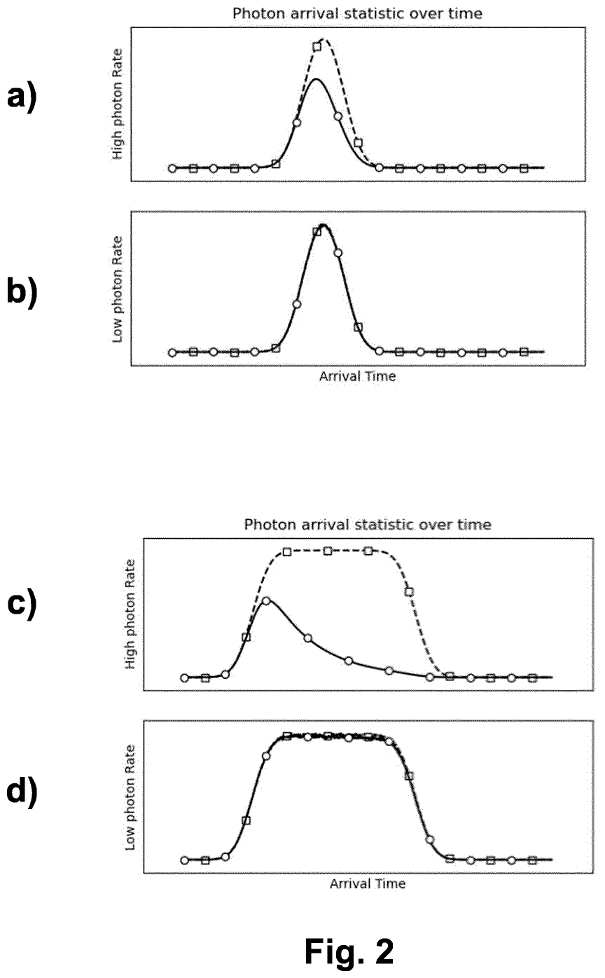

FIGS. 2a, b, c, and d visualize the dependency of the pile-up effect on the signal strength.

In FIGS. 2a, b, c, and d the dashed lines (labeled with squares) indicate the number of detected photons without pile-up over multiple frames, and the solid lines (labeled with circles) indicate the detected photons over multiple frames with pile-up.

FIG. 2a shows the number of detected photons without pile-up (dashed line, labeled with squares) versus the number of detected photons with pile-up (solid line, labeled with circles) for a narrow pulse at high photon rate. At high photon rates, due to dead time (“pile-up” effect), the histogram of the detected photons does not correspond to the incoming photons statistic. The local maximum of the detected histogram is shifted to the left, underestimating the ToF.

FIG. 2b shows the number of detected photons without pile-up (dashed line, labeled with squares) versus the number of detected photons with pile-up (solid line, labeled with circles) for a narrow pulse at low photon rate. When the photon rate is low, no major discrepancies are observed between the histogram shapes.

FIG. 2c shows the number of detected photons without pile-up (dashed line, labeled with squares) versus the number of detected photons with pile-up (solid line, labeled with circles) for a large pulse at high photon rate. At high photon rates, due to dead time (“pile-up” effect), the histogram of the detected photons does not correspond to the incoming photons statistic. The local maximum of the detected histogram is shifted to the left, underestimating the ToF.

FIG. 2d shows the number of detected photons without pile-up (dashed line, labeled with squares) versus the number of detected photons with pile-up (solid line, labeled with circles) for a large pulse at low photon rate. At low photon rates, the number of detected photons is approximately the same as the number of incoming photons. When the photon rate is low, no major discrepancies are observed between the histogram shapes.

A massive pile-up such as in FIGS. 2a and 2c cannot be corrected precisely, because information is lost due to photon pile-up and cannot be algorithmically recovered.

### Subframe Acquisition

The embodiments described below in more detail optimize the illumination of a Photon Counting, or other SPAD based depth measurement system by minimizing the impact of pile-up and thus improving accuracy.

The technology of the embodiments described below avoids or mitigates the pile-up and can be beneficially applied in particular when the pile-up is strong.

The embodiments describe a Time-of-Flight system comprising a Photon Counting ToF sensor and active illumination means. The illumination means illuminate a scene with pulses of laser light that are emitted with predefined time shifts. The photons of reflected light that are captured by the ToF sensor are evaluated in a photon histogram. The photon counts from multiple recording periods are aggregated into a photon histogram. The recording periods of a photon histogram are attributed to groups which are here denoted as “subframes”. A subframe is a collection of recording periods with the same time shift. The recording time slots of a recording period are all shifted by the same time shift as the respective illumination pulses that belong to the subframe. A frame is a collection of measurements (subframes) from which we can extract depth information. A frame is a pattern of subframes that is repeating in time.

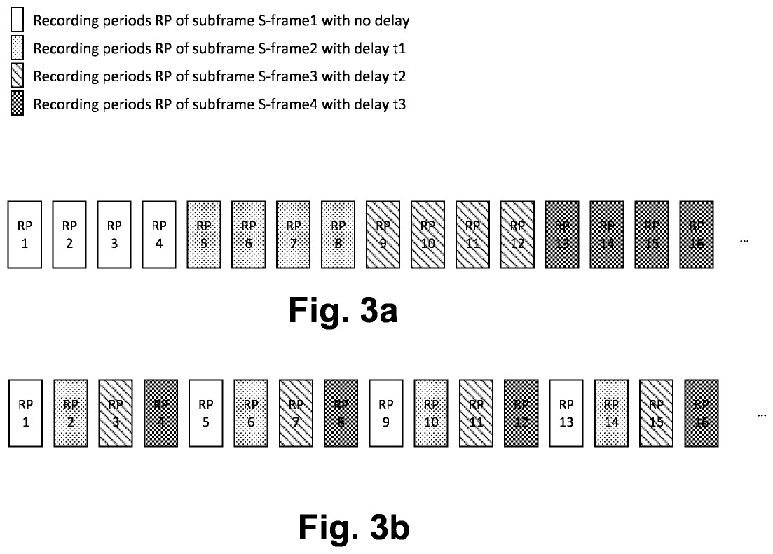

FIG. 3a shows a first example of a sub-frame definition. Recording periods RP1, RP2, . . . , RP16 of one frame follow in time one after each other. The first four recording periods RP1 to RP4 are attributed to a first sub-frame S-frame1. There is no delay defined for the recording time slots of this sub-frame S-Frame1. The next four recording periods RP5 to RP8 are attributed to a second sub-frame S-frame2. A delay t1 is defined for the recording time slots of this sub-frame S-Frame2. The next four recording periods RP9 to RP12 are attributed to a third sub-frame S-frame3. A delay t2 is defined for the recording time slots of this sub-frame S-Frame3. The next four recording periods RP13 to RP16 are attributed to a fourth sub-frame S-frame4. A delay t3 is defined for the recording time slots of this sub-frame S-Frame4. That is, in this example, the sub-frames S-Frame1, S-Frame2, S-Frame3, and S-Frame4 with respective time delays 0, t1, t2, t3, t4 follow in time one after each other.

FIG. 3b shows a second example of a sub-frame definition. As in the example of FIG. 3a, recording periods RP1, RP2, . . . , RP16 of one frame follow in time one after each other. Recording periods RP1, RP5, RP9, and RP13 are attributed to a first sub-frame S-frame1. There is no delay defined for the recording time slots of this sub-frame S-Frame1. Recording periods RP2, RP6, RP10, and RP14 are attributed to a second sub-frame S-frame2. A delay t1 is defined for the recording time slots of this sub-frame S-Frame2. Recording periods RP3, RP7, RP11, and RP15 are attributed to a third sub-frame S-frame3. A delay t2 is defined for the recording time slots of this sub-frame S-Frame3. Recording periods RP4, RP8, RP12, and RP16 are attributed to a fourth sub-frame S-frame4. A delay t3 is defined for the recording time slots of this sub-frame S-Frame4. That is, in this example, the sub-frames S-Frame1, S-Frame2, S-Frame3, and S-Frame4 are associated with respective time delays 0, t1, t2, t3, and the recording periods of the sub-frames are interleaved.

It should however be noted that the order of the subframes is not important.

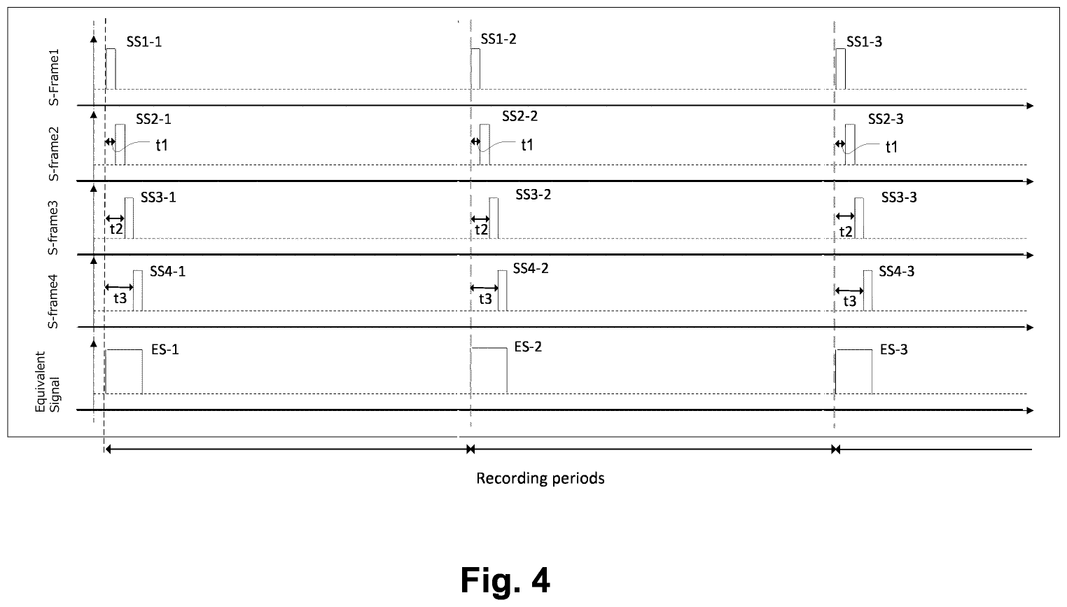

FIG. 4 schematically shows subframe signals for which the recording time slots are defined such that their sum would be equivalent to the signal waveform specified for the system. In a first subframe S-Frame1, subframe signals SS1-1, SS1-2, SS1-3 of a predefined length are acquired during respective recording time slots. The recording time slots of the subframe signals SS1-1, SS1-2, SS1-3 correspond in timing to the illumination pulses, i.e. there is no time shift (time shift t0=0) between the frame signals SS1-1, SS1-2, SS1-3 (recording time slots) and the illumination pulses. In a second subframe S-Frame2, subframe signals SS2-1, SS2-2, SS2-3 of a length similar to that of subframe signals SS1-1, SS1-2, SS1-3 of the first subframe S-Frame1 are acquired during respective recording time slots. Subframe signals SS2-1, SS2-2, SS2-3 are recorded with a time shift t1 between the illumination pulse and the recording time slots within the recoding period. In a third subframe S-Frame3, subframe signals SS3-1, SS3-2, SS3-3 of a length similar to that of subframe signals SS1-1, SS1-2, SS1-3 of the first subframe S-Frame1 are acquired during respective recording time slots. Subframe signals SS3-1, SS3-2, SS3-3 are recorded with a time shift t2 between the illumination pulse and the recording time slots within the recoding period. In a fourth subframe S-Frame4, subframe signals SS4-1, SS4-2, SS4-3 of a length similar to that of subframe signals SS1-1, SS1-2, SS1-3 of the first subframe S-Frame1 are acquired during respective recording time slots. Subframe signals SS4-1, SS4-2, SS4-3 are recorded with a time shift t3 between the illumination pulse and the recording time slots within the recoding period. Length and number of the subframe signals is configured in such a way that the sum, i.e. the equivalent signal ES-1, ES-2, or respectively, ES-3, of the subframe signals of subframes S-Frame1, S-Frame2, S-Frame3, and S-Frame4 is equivalent to the signal waveform required by the system.

The time delays t1, t2, and t3 in FIG. 3 can for example be generated by introducing a time shift in the generation of the illumination signal, i.e. by shifting the illumination onset as displayed in the embodiments of FIGS. 3a, b, and c below.

In the example of FIG. 4, the illumination pulses are non-overlapping, which is preferred.

Still further, in the embodiment of FIG. 4 the time shift increment (t1-t0, t2-t1, t3-t2) between the subframes is substantially uniform. In alternative embodiments, the time shift increments may be chosen arbitrarily. In case of time shift with non-uniform increment, the length of the illumination pulse is preferably at least equal to the duration of the longest time shift increment.

The illumination pulses for the subframes S-frame1, . . . , Sframe-4 in the example of FIG. 4 are, compared to a target pulse (ES-1, ES-2, ES-3, ES-4), short pulses with increased pulse power. The target pulse can be for example 5 ns while short pulses with increased power can each be of about 1 ns. (with this example a bin period can be 5 ns).

Each of the subframe signals accumulated over time corresponds to the known single pulse condition. Illumination peak power for the single pulses in the subframes can for example be configured to maximize the peak power of the pulses, remaining eye safe and maximize SNR.

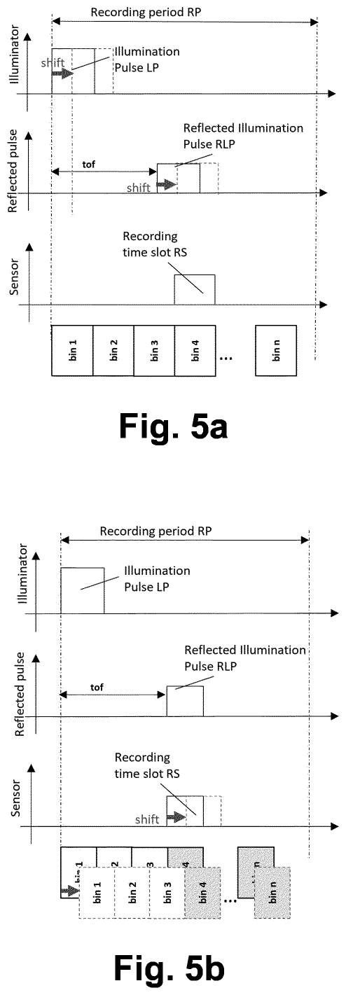

In FIG. 5a, an illumination pulse LP (dashed lines) is generated by an illuminator with a variable time shift with respect to the beginning of a recording period RP. Within the recording period RP, the sensor captures a respective shifted reflected pulse RLP (dashed lines) with a time delay that corresponds to the time of flight tof. Photons from that reflected illumination pulse RLP arrive at the sensor during recording time slot RS.

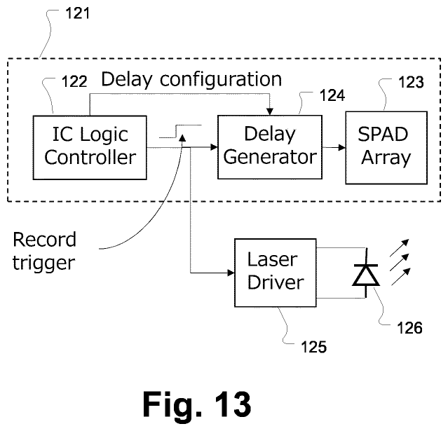

In FIG. 5b, an illumination pulse LP is generated, by an illuminator, at the beginning of a recording period RP. Within the recording period RP, the sensor captures a respective reflected illumination pulse RLP with a time delay that corresponds to the time of flight tof. As indicated by the arrow, the recording time slots RS within the recording period RP are shifted by a variable time shift (e.g. generated by delay generator 124 in FIG. 13) with respect to the beginning of the recording period RP.

That is, the subframes are recorded with a time shift between the illumination pulse LP and the recording time slot RS within the recording. As explained below in more detail, this shifting of the pulse while not reducing its length does not have a significant impact on the SNR.

The time frame between the onset of the illumination pulse and the onset of the recording time slot may be slightly varied due to the shift, also the expected ToF is not kept constant for the subframes.

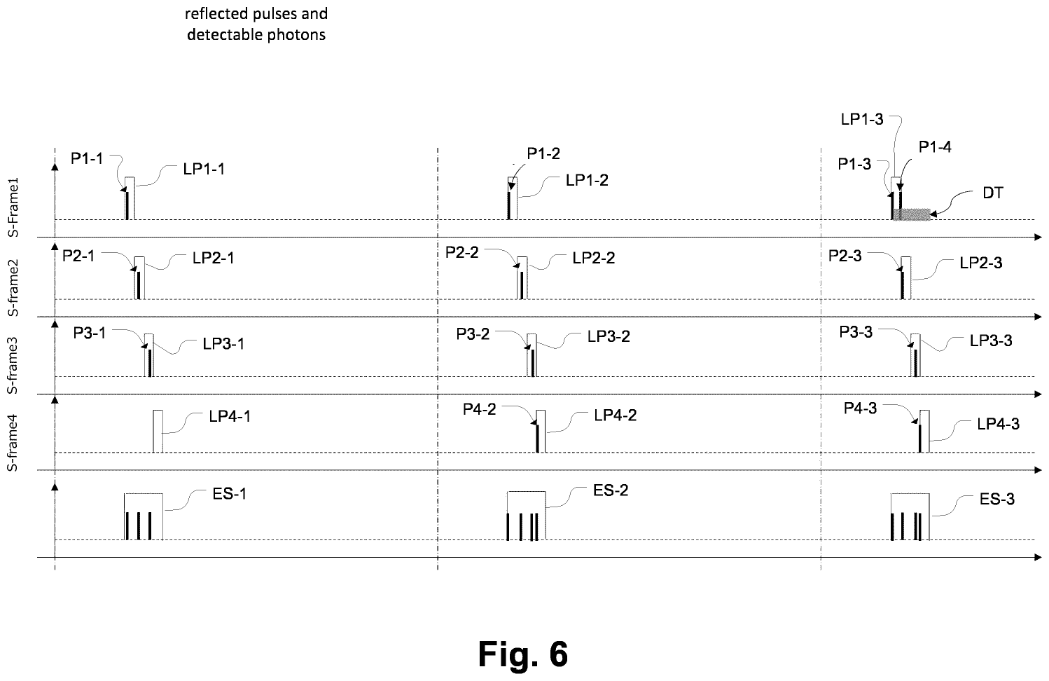

Using such optimization approach allows to compensate the effect of pile-up, as it is shown in FIG. 6 below.

FIG. 6 schematically shows the effect of pile-up mitigation caused by the subframe illumination. In the diagrams of FIG. 6 is shown the detectable photons arrival for four subframes S-Frame1, S-Frame2, S-Frame3, and S-Frame4 and the four subframes equivalent signal ES, using the pulse reconstruction technique. Three exemplary illumination periods follow after each other in time. Illumination pulses LP1-1, . . . , LP4-3 which correspond to respective reflected illumination pulses (detectable photons) are generated and light pulses are shifted in four subframes S-Frame1, S-Frame2, S-Frame3, and S-Frame4 by respective offsets as set out with regard to FIGS. 4 and 5a, 5b above. The pulse width is kept constant over the subframes. During the first illumination period, a photon P1-1 is detectable during illumination pulse LP1-1 of subframe S-Frame1, a photon P2-1 is detectable during illumination pulse of LP2-1 of subframe S-Frame2, a photon P3-1 is detectable during illumination pulse LP3-1 of subframe S-Frame3, and no photons are detectable during illumination pulse LP4-1 of subframe S-Frame4. This results in three photons P1-1, P2-1, and P3-1 being detectable in the equivalent light pulse signal ES-1 of the first illumination period. During the second illumination period, a photon P1-2 is detectable during illumination pulse LP1-2 of subframe S-Frame1, a photon P2-2 is detectable during illumination pulse LP2-2 of subframe S-Frame2, a photon P3-2 is detectable during illumination pulse LP3-2 of subframe S-Frame3, and a photon P4-2 is detectable during illumination pulse LP4-2 of subframe S-Frame4. This results in four photons P1-2, P2-2, P3-2, and P4-2 being detectable in the equivalent light pulse signal ES-2 of the second illumination period. During the third illumination period, a photon P1-3 is detectable during illumination pulse of LP1-3 of subframe S-Frame1. Photon P1-4, which follows shortly after photon P1-3 is not detectable during illumination pulse LP1-3 of subframe S-Frame1 because of the dead time of the sensor. A photon P2-3 is detectable during illumination pulse LP2-3 of subframe S-Frame2, a photon P3-3 is detectable during illumination pulse LP3-3 of subframe S-Frame3, and a photon P4-3 is detectable during illumination pulse LP4-3 of subframe S-Frame4. This results in four photons P1-3, P2-3, P3-3, and P4-3 being detectable in the equivalent light pulse signal ES-3 of the third illumination period. As shown in FIG. 6, by splitting the illumination pulse (i.e. the wanted signal waveform required by the system) in smaller sub-signals, the risk of pile-up due to sensor dead time DT gets reduced, and if it happens, its impact is limited. By splitting the main light pulse into narrower pulses, the probability of missing an active photon due to the dead time is reduced. Effectively, by using several narrower pulses, the probability of having multiple detectable photons in the pulses get reduced. Also, if some photons are missed within one of the narrower pulses, the impact is reduced.

According to the example of FIG. 6, illumination pulses for the subframes from the active illumination means are narrower pulses, which when averaged are reconstructing the equivalent light pulse signal (without subframes) when building the ToF histogram.

By increasing the pulse power for a short pulse, the number of frames can be increased without reducing the SNR. That is, despite the presence of ambient light, reducing the pulse length and increasing the number of frames does not reduce the SNR at long distance, if the pulse power is increased accordingly.

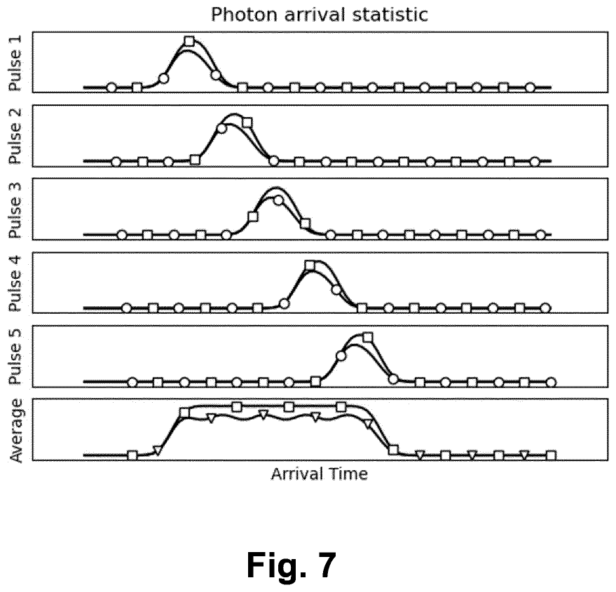

FIG. 7 shows an equivalent arrival of detectable photons that is decomposed in to five shorter arrivals of detectable photons: “Pulse 1”, “Pulse 2”, “Pulse 3”, “Pulse 4”, and “Pulse 5”. The shorter arrivals of detectable photons are used in five different subframes according to the principles described with regard to FIGS. 4 to 6 above. The arrival time of photons corresponds to the horizontal axis. The lines labeled with squares indicate the number of incoming photons over multiple frames, and the lines labeled with circles indicate the detectable photons over multiple frames. The average statistical results “Average” (lines with triangles) reconstruct a better square equivalent detectable photons signal.

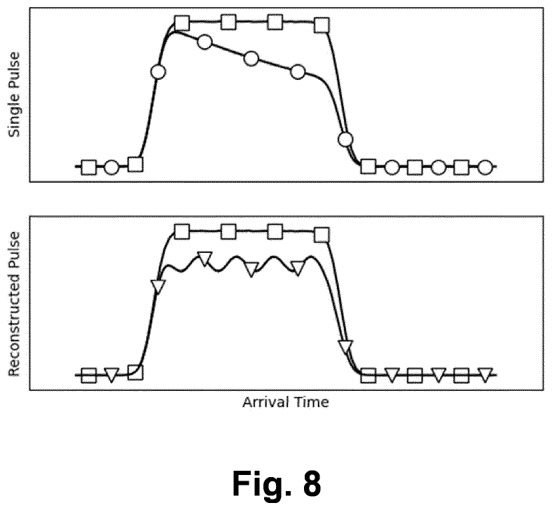

FIG. 8 compares the reconstructed equivalent detectable photon signal obtained according to the sub-pulse scheme technique of the present embodiments with a single detectable photon signal that does not use the sub-pulse scheme of the present embodiments. The upper plot shows a comparison between the incoming photons (squares), and the detectable photons (circles) when the signal is a single wide light pulse. The lower plot shows a comparison between the incoming photons (squares), and the detectable photons (triangles) when the signal is constructed by successive smaller light pulses (see also “Average” pulse in the lower row of FIG. 7).

The equivalent signal (reconstructed pulse) as constructed by successive smaller pulses can then be used to determine a ToF delay based on the principle of binning that is well known to the skilled person.

Determining equivalent signal as constructed by successive smaller subframe pulses may improve the dynamic range of the Photon Counting system by mitigating the pile-up effect. This may allow to correct non-linearity effects induced by pulses being shorter than the bin.

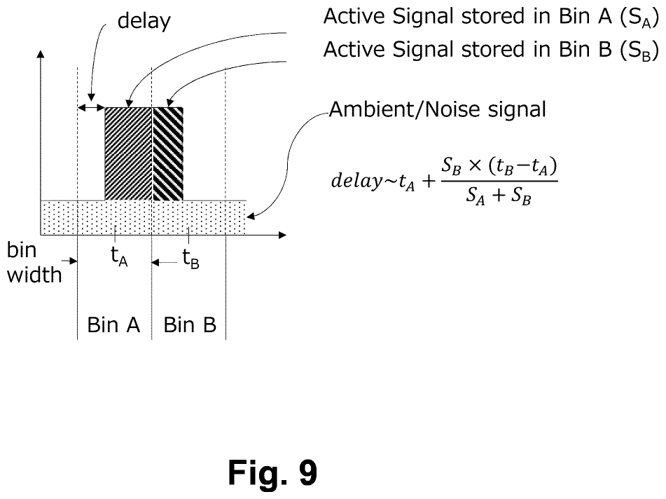

FIG. 9 schematically shows an example of a ToF delay computation based on the principle of binning. According to the principle of binning, the time domain is structured into bins. The bins are defined by a record trigger signal (see FIGS. 11 and 13 below). The active signal obtained by the detector is stored in these bins according to the arrival time of the photons. In the schematic example of FIG. 9, the rectangle filled with the thin dashed pattern shows the active signal S_{A} obtained in Bin A. The rectangle filled with the thick dashed pattern shows the active signal S_{B} obtained in Bin B. The rectangle filled with the dotted pattern shows the ambient/noise signal. In this situation, the ToF delay can be computed according to

$$delay ∼ {t}_{A} + \frac{{S}_{B} \times ( {t}_{B} - {t}_{A} )}{{S}_{A} + {S}_{B}}$$

where t_{A} indicates the position of Bin A in the time domain and where t_{B} indicates the position of Bin B in the time domain.

It should be noted that the above formula is only an example to show that it is possible to increase the timing resolution below the timing resolution of the taps themselves. The formula is valid when the illumination pulse duration is equal to the tap/bin duration, with the hypotheses that the laser pulse and the recording time slot are square signals. If the illumination pulse is longer than the tap duration, the formula can be adapted accordingly.

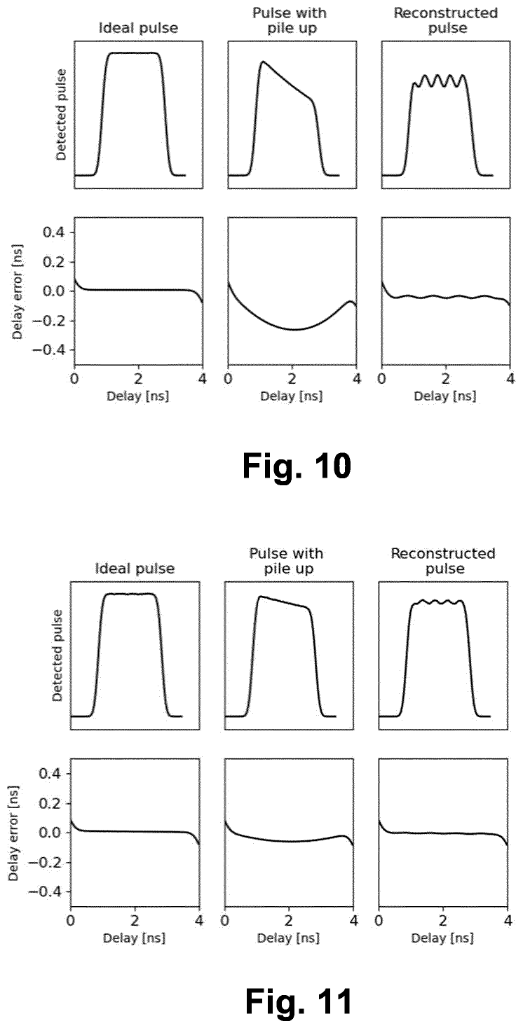

Considering the method of depth calculation shown in the embodiments above, as an example, the average depth error can be computed and compared between standard illumination (standard rectangular pulse) and reconstructed pulses in case of strong pile-up (FIG. 10), and moderate pile-up (FIG. 11).

FIG. 10 shows the impact of the detected pulse shape on the time of flight delay estimation in case of high intensity signals. On the left is shown the ideal case “ideal pulse” without any pile-up. In the middle it is shown the case “Pulse with pile-up” where the detected pulse is strongly impacted by pile-up. On the right it is shown the case “Reconstructed pulse” where the pulse is an equivalent pulse reconstructed from shorter sub-pulses as described in the embodiments above. The lower plots show the delay error in nano seconds [ns] as a function of the actual delay [ns]. It can be seen that the use of pulse reconstruction is reducing significantly the effect of pile-up.

FIG. 11 shows the impact of the detected pulse shape on the time of flight delay estimation in case of moderate intensity signals, where the detected pulse is not much impacted by pile-up. The lower plots show the delay error in nano seconds [ns] as a function of the actual delay [ns]. The use of pulse reconstruction reduces the effect of pile-up.

That is, the embodiments allow a strong improvement when signal intensity is strong without degrading the depth when lower signal intensity is being detected by the sensor.

### Implementation

Possible hardware implementations are depicted in FIGS. 11 and 13. A programmable delay generator is introduced delaying either the pulse trigger signal, or the reference clock of the histogram recording systems.

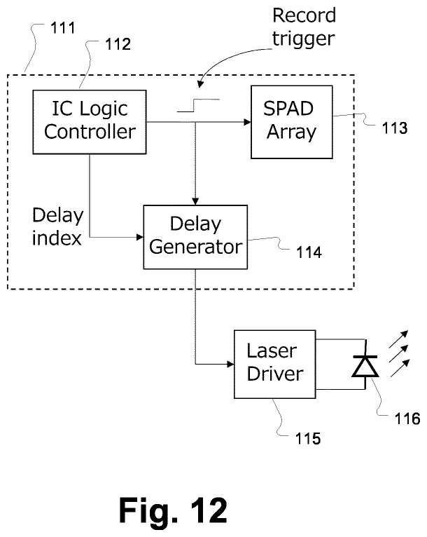

FIG. 12 schematically shows an embodiment of a ToF device. The ToF device 111 comprises an IC logic controller 112, a SPAD array 113, and a programmable delay generator 114. A laser driver 115 is configured to drive a laser 116. The IC logic controller 112 generates a SPAD record trigger signal which controls the SPAD array 113. SPAD record trigger signal obtained from IC logic controller 112 is passed through programmable delay generator 114 which is used between the SPAD record trigger signal and the laser driver 115 in order to delay the laser trigger signal as function of the subframe. For example, the IC logic controller 112 may control the delay generator 114 by a delay index which indicates the delay and represents the delay configuration.

FIG. 13 schematically shows an alternative embodiment of a ToF device. The ToF device 121 comprises an IC logic controller 122, a SPAD array 123, and a programmable delay generator 124. A laser driver 125 is configured to drive a laser 126. The IC logic controller 122 generates a SPAD record trigger signal which is sent to laser driver 125 as a laser trigger signal. Based on the SPAD record trigger signal received from IC logic controller 122, laser driver 125 controls laser 126 to produce a laser pulse. IC logic controller 122 further generates a delay configuration and sends this delay configuration to programmable delay generator 124 together with the SPAD record trigger signal. Programmable delay generator 124 delays the SPAD record trigger signal based on the delay configuration and controls the recording in SPAD array 123 based on the delayed trigger signal. Programmable delay generator 124 is thus used to modify the SPAD record trigger signal between the laser trigger signal and the SPAD array recording. As in the example of FIG. 12, the IC logic controller 122 may control the delay generator 124 by a delay index which indicates the delay and represents the delay configuration.

It should be noted that the description above is only an example configuration. Alternative configurations may be implemented with additional or other units, sensors, or the like.

It should also be noted that the division of the device of FIGS. 11 and 12 into units is only made for illustration purposes and that the present disclosure is not limited to any specific division of functions in specific units.

It should further be noted that the embodiments are not constrained by a particular detection technique. The SPAD technology is only described as an example.

It should also be recognized that the embodiments describe methods with an exemplary ordering of method steps. The specific ordering of method steps is, however, given for illustrative purposes only and should not be construed as binding.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:
(1) A Time-of-Flight system of the photon counting type comprising circuitry configured to generate illumination pulses (LP) and to record the reflected illumination pulses (RLP) in recording time slots (RS) within a recoding period (RP) with variable time shifts (t0, t1, t2, t3) between the illumination pulses (LP) and the recording time slots (RS).
(2) The Time-of-Flight system of (1), wherein the circuitry is configured to acquire, during a recording period (RP), a photon counting histogram, each bin of the photon counting histogram corresponding to recording time slots (RS) of the recording period (RP).
(3) The Time-of-Flight system of (1) or (2), wherein the circuitry is configured to acquire frames comprising recording periods (RP).
(4) The Time-of-Flight system of any one of (1) to (3), wherein the circuitry is configured to acquire, for each frame, subframes (S-frame1, . . . , Sframe-4), wherein each subframe is a collection of recording periods (RP) with the same time shift (t0, t1, t2, t3).
(5) The Time-of-Flight system of any one of (1) to (4), wherein the illumination pulse (LP) duration is at least as long as the longest time shift increment.
(6) The Time-of-Flight system of any one of (1) to (5), wherein the circuitry is configured to control the time shift within the recording period (RP) by shifting the illumination onset.
(7) The Time-of-Flight system of any one of (1) to (6), wherein the circuitry is configured to control the time shift within the recording period (RP) by shifting the recording time slot (RS).
(8) The Time-of-Flight system of any one of (4) to (7), wherein the illumination pulses (LP) for the subframes (S-frame1, . . . , Sframe-4) are defined based on a target equivalent pulse (ES) of the corresponding frame such that the illumination pulses (LP) of the subframes (S-frame1, . . . , Sframe-4) are equal to the target equivalent pulses (ES) of the frame.
(9) The Time-of-Flight system of (8), wherein the illumination pulses for the subframes (S-frame1, . . . , Sframe-4) are, compared to a target pulse (ES), short pulses with increased pulse power.
(10) The Time-of-Flight system of any one of (1) to (9), wherein the circuitry comprises a Photon Counting ToF sensor (113; 123) configured to record the reflected illumination pulses (RLP).
(11) The Time-of-Flight system of any one of (1) to (10), wherein the circuitry comprises an active illuminator (115, 116; 125, 126).
(12) The Time-of-Flight system of any one of (1) to (11), wherein the circuitry comprises a programmable delay generator (114) which is configured to delay an illumination pulse trigger signal.
(13) The Time-of-Flight system of any one of (1) to (12), wherein the programmable delay generator (114) is configured to delay the illumination pulse trigger signal as function of the subframe.
(14) The Time-of-Flight system of any one of (1) to (13), wherein the circuitry comprises a programmable delay generator (124) configured to delay the reference clock of histogram recording.
(15) The Time-of-Flight system of any one of (1) to (14), wherein the circuitry comprises a programmable delay generator (124) configured to modify a trigger for SPAD array recording.
(16) The Time-of-Flight system of any one of (1) to (15), wherein the circuitry is configured to perform a ToF delay computation based on the principle of binning, where each bin corresponds to a recording time slot (RS) of the frame.
(17) The Time-of-Flight system of (16), wherein the recording time slots (RS) are defined by a record trigger signal.
(18) The Time-of-Flight system of any one of (1) to (17), wherein the circuitry is configured to generate illumination pulses (LP) and to record respective reflected illumination pulses (RLP) in recording time slots (RS) within respective recoding periods (RP) with variable time shifts (t0, t1, t2, t3) between the illumination pulses (LP) and the recording time slots (RS).
(19) A method comprising generating illumination pulses (LP) and recording respective reflected illumination pulses (RLP) in recording time slots (RS) within respective recoding periods (RP) with variable time shifts (t0, t1, t2, t3) between the illumination pulses (LP) and the recording time slots (RS).

1. A Time-of-Flight system of the photon counting type comprising circuitry configured to generate illumination pulses and to record the reflected illumination pulses in recording time slots within a recoding period with variable time shifts between the illumination pulses and the recording time slots.

2. The Time-of-Flight system of claim 1, wherein the circuitry is configured to acquire, during a recording period, a photon counting histogram, each bin of the photon counting histogram corresponding to recording time slots of the recording period.

3. The Time-of-Flight system of claim 1, wherein the circuitry is configured to acquire frames comprising recording periods.

4. The Time-of-Flight system of claim 1, wherein the circuitry is configured to acquire, for each frame, subframes, wherein each subframe is a collection of recording periods with the same time shift.

5. The Time-of-Flight system of claim 1, wherein the illumination pulse duration is at least as long as the longest time shift increment.

6. The Time-of-Flight system of claim 1, wherein the circuitry is configured to control the time shift within the recording period by shifting the illumination onset.

7. The Time-of-Flight system of claim 1, wherein the circuitry is configured to control the time shift within the recording period by shifting the recording time slot.

8. The Time-of-Flight system of claim 4, wherein the illumination pulses for the subframes are defined based on a target equivalent pulse of the corresponding frame such that the illumination pulses of the subframes are equal to the target equivalent pulses of the frame.

9. The Time-of-Flight system of claim 8, wherein the illumination pulses for the subframes are, compared to a target pulse, short pulses with increased pulse power.

10. The Time-of-Flight system of claim 1, wherein the circuitry comprises a Photon Counting ToF sensor configured to record the reflected illumination pulses.

11. The Time-of-Flight system of claim 1, wherein the circuitry comprises an active illuminator.

12. The Time-of-Flight system of claim 1, wherein the circuitry comprises a programmable delay generator which is configured to delay an illumination pulse trigger signal.

13. The Time-of-Flight system of claim 12, wherein the programmable delay generator is configured to delay the illumination pulse trigger signal as function of the subframe.

14. The Time-of-Flight system of claim 1, wherein the circuitry comprises a programmable delay generator configured to delay the reference clock of histogram recording.

15. The Time-of-Flight system of claim 1, wherein the circuitry comprises a programmable delay generator configured to modify a trigger for SPAD array recording.

16. The Time-of-Flight system of claim 1, wherein the circuitry is configured to perform a ToF delay computation based on the principle of binning, where each bin corresponds to a recording time slot of the frame.

17. The Time-of-Flight system of claim 16, wherein the recording time slots are defined by a record trigger signal.

18. The Time-of-Flight system of claim 1, wherein the circuitry is configured to generate illumination pulses and to record respective reflected illumination pulses in recording time slots within respective recoding periods with variable time shifts between the illumination pulses and the recording time slots.

19. A method comprising generating illumination pulses and recording respective reflected illumination pulses in recording time slots within respective recoding periods with variable time shifts between the illumination pulses and the recording time slots.
